(19) United States
(12) Patent Application Publication
(10) Pub. No.: US 2009/0240501 A1
(43) Pub. Date: Sep. 24, 2009

(54) AUTOMATICALLY GENERATING NEW WORDS FOR LETTER-TO-SOUND CONVERSION

(75) Inventors: Yi Ning Chen, Beijing (CN); Jia Li You, Beijing (CN); Frank Kao-ping Soong, Beijing (CN)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/050,947

(22) Filed: Mar. 19, 2008

(51) Int. Cl. G10L 11/04

(52) U.S. Cl. 704/260; 704/E13.011

(57) ABSTRACT

Described is a technology by which artificial words are generated based on seed words, and then used with a letter-to-sound conversion model. To generate an artificial word, a stressed syllable of a seed word is replaced with a different syllable, such as a candidate (artificial) syllable, when the phonemic structure and/or graphonemic structure of the stressed syllable and the candidate syllable match one another. In one aspect, the artificial words are provided for use with a letter-to-sound conversion model, which may be used to generate artificial phonemes from a source of words, such as in conjunction with other models. If the phonemes provided by the various models for a selected source word are in agreement relative to one another, the selected source word and an associated artificial phoneme may be added to a training set which may then be used to retrain the letter-to-sound conversion model.

### BACKGROUND

In recent years, the field of text-to-speech (TTS) conversion has been largely researched, with text-to-speech technology appearing in a number of commercial applications. One stage in text-to-speech systems is converting from text to phonemes. In general, a reasonably large dictionary (e.g., a pronunciation lexicon) is used to determine the proper pronunciation of each word. However, no matter how large the lexicon is, some out-of-vocabulary words are not present, such as proper names, names of places and the like.

For such out-of-vocabulary words, a mechanism is needed to predict the pronunciation of words based upon their spelling. This is referred to as letter-to-sound (LTS) conversion, and for example may be implemented in a letter-to-sound software module.

Manually constructed rules and data-driven algorithms have been used for letter-to-sound conversion. However, manually constructed rules require the expert knowledge of a linguist, which among other drawbacks is difficult to extend from one language to another.

Data-driven techniques include methods based on decision trees, a hidden Markov model (HMM), N-gram models, maximum entropy models, and transformation-based error-driven approach. In general, these data-driven techniques are automatically trained and language-independent, yet nevertheless require training data provided by an expert's guesses at the correct pronunciations of such words. As a general principle, the more training data that is available, the better the results; however, because of the need for experts in putting together the training data, it is not practical to obtain a large word list that has corresponding pronunciations.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards a technology by which artificial words are generated based on seed words, and then used to provide a letter-to-sound conversion model. In one example, to generate an artificial word, a stressed syllable of a seed word is replaced with a different syllable. For example, a stressed syllable of the seed word is compared against a candidate syllable, and if the syllables sufficiently match, the stressed syllable of the seed word is replaced with the candidate syllable to generate the new word. In one example implementation, the stressed syllable and the candidate syllable are each represented as a phonemic structure which may be compared with one another to determine if they match, in which case the artificial word is generated; graphonemic structure matching may be similarly used.

In one aspect, candidate parts of speech corresponding to a seed word are provided, and evaluated against a similar part of a seed word to determine whether an evaluation rule is met. For example, the candidate part of speech may be a candidate syllable, and the similar part of the seed word may be a primary stressed syllable; if phonemic and/or graphonemic rules indicate a match, an artificial word is generated from the candidate syllable and another part of the seed word, e.g., the non-primary stressed syllable or syllables.

In one aspect, the artificial words are provided for use with a letter-to-sound conversion model. The letter-to-sound conversion model may be used to generate artificial phonemes from a source of words, such as in conjunction with other models. Then, for example, if the phonemes provided by the various models for a selected source word are in agreement relative to one another with respect to an agreement threshold, the selected source word and an associated artificial phoneme may be added to a training set. The training set may then be used to retrain the letter-to-sound conversion model.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is a block diagram representing an example system for providing a letter-to-sound model based at least in part on artificially generated data.

FIG. 2 is a flow diagram showing example steps taken to generate new words.

FIG. 3 is a flow diagram showing example steps of a mutual information algorithm used for chunk extraction in predicting word pronunciations.

FIG. 4 is a representation of artificial word generation by phonemic and graphonemic-based replacement rules.

FIG. 5 is a block diagram representing an example system for predicting and retraining pronunciations of new words based on semi-supervised learning and agreement.

FIG. 6 shows an illustrative example of a computing environment into which various aspects of the present invention may be incorporated.

### DETAILED DESCRIPTION

Various aspects of the technology described herein are generally directed towards generating artificial data (e.g., words) and using them as training data to improve letter-to-sound (LTS) conversion accuracy. As will be understood, one example system generates artificial words based upon the pronunciations of existing words, including by replacing the stressed syllables of each word with stressed syllables from other words, if they are deemed close enough. Another mechanism is directed towards finding a large set of words, such as from the Internet, to generate a very large word list (corpus), which may then be used directly for pronunciations, or used for pronunciations when a confidence measure is sufficiently high.

While various aspects are thus directed towards using artificial words to improve the performance of letter-to-sound conversion, including by creating artificial words by swapping the stressed syllable of different words, and/or by swapping stressed syllables when they are sufficiently similar, other uses for the artificial words are feasible, such as in speech recognition. As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used various ways that provide benefits and advantages in computing, and data generation in general.

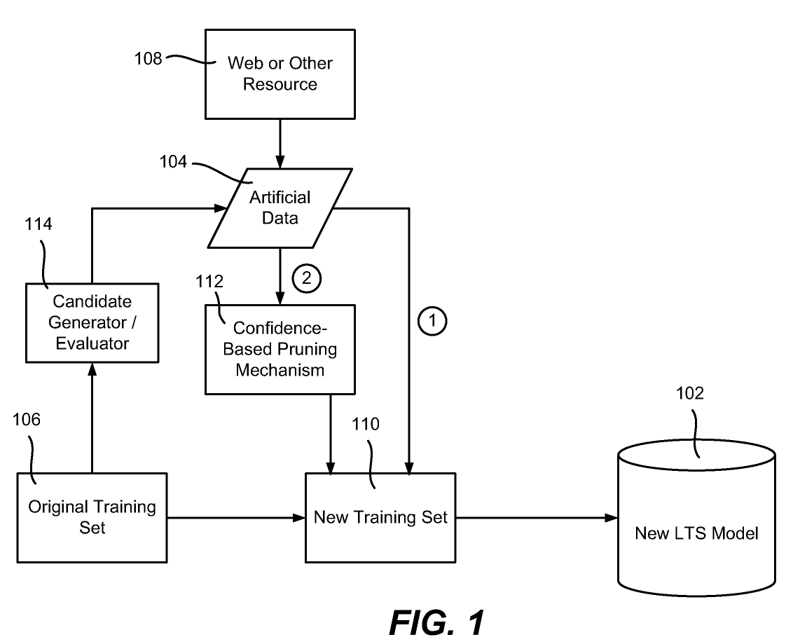

Turning to FIG. 1, there is shown a general representation of various aspects/components related to the creation of an improved letter-to-sound model 102 based upon artificial data 104. In general, the artificial data 104 may be based upon an original training set 106 and/or data obtained from the web or other resource (such as a large database) 108.

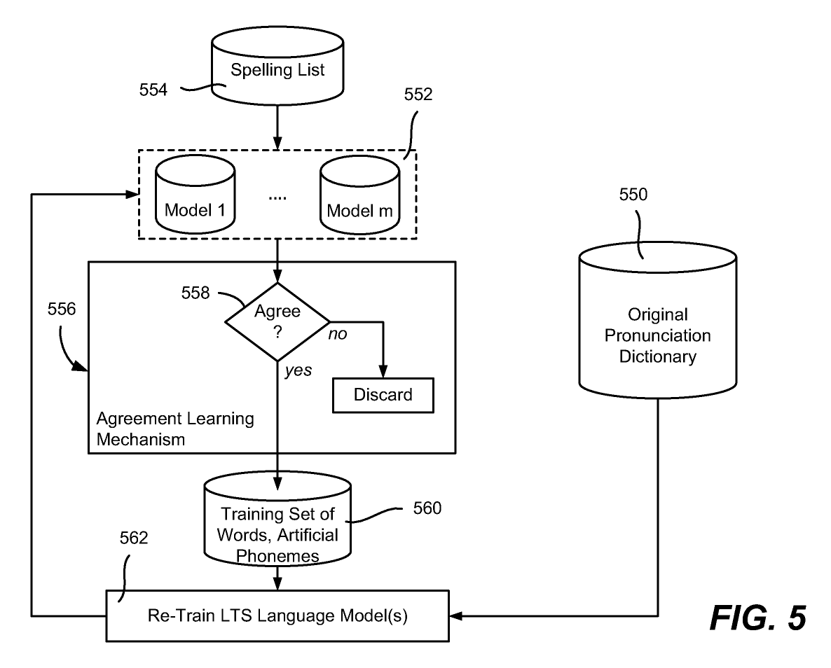

As described below, the artificial data 104 may be directly used (with one or more phoneme prediction models) to provide a new training set 110, as represented in FIG. 1 by the arrow accompanied by the circled numeral one (1). Alternatively, (or in addition to direct usage), via a mechanism 112, the artificial data 104 may be pruned based on a confidence measure to provide the new training set 110, as represented in FIG. 1 by the arrow accompanied by the circled numeral two (2), and as described below with reference FIG. 5.

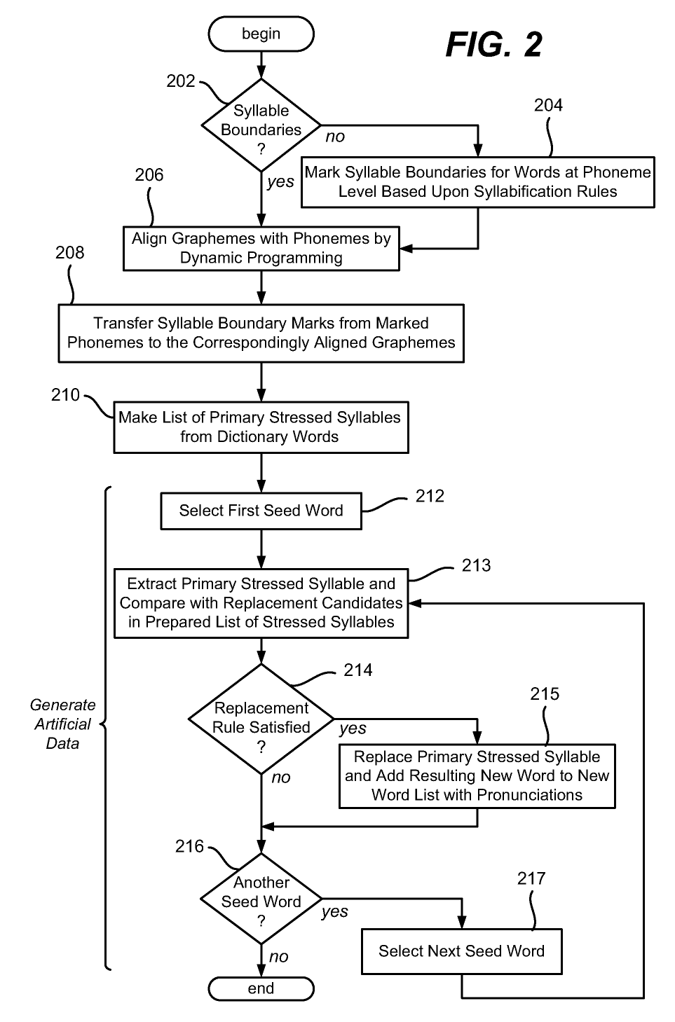

FIG. 2 is a flow diagram representing an example process (e.g., included in a candidate generator/evaluator 114) for generating artificial (new) words, including by generating artificial words based upon replacing stressed syllables. More particularly, given a pronunciation dictionary, step 202 evaluates whether the dictionary includes syllable boundaries. If not, at step 204 the dictionary words are marked with syllable boundaries at the phoneme level based upon known syllabification rules.

Step 206 aligns graphemes with the phonemes using one or more dynamic programming techniques, such as described in Black, A. W., Lenzo, K. and Pagel, V., “Issues in Building General Letter to Sound Rules”, in Proc. of the 3rd ESCA Workshop on Speech Synthesis, pp. 77-80 1998 and Jiang, L., Hon, H., and Huang, X., “Improvements on a Trainable Letter-to-Sound Converter”, in Proc. of Eurospeech, pp. 605-608, 1997. More particularly, in one example, N-gram statistical modeling techniques have been applied successfully to speech, language and other data of sequential nature. In letter-to-sound conversion, N-gram modeling has also been effective in predicting word pronunciation from its letter spellings. The relationship among grapheme-phoneme (Graphoneme) pairs is modeled as Equation (1):

$$\begin{matrix}\tilde{S} = {\text{arg} max}_{S} \{ P ( S \vert L ) \} \\ = {\text{arg} max}_{S} \{ P ( S , L ) \} \\ = {\text{arg} max}_{S} \{ {\prod }_{i = 1}^{n} P ( {g}_{i} \vert {g}_{i - 1} , … , {g}_{1} ) \}\end{matrix} \qquad ( 1 )$$

where L={l₁, l₂, . . . , lₙ} is the grapheme sequence of a word W; S={s₁,s₂, . . . ,sₙ} is the phoneme sequence; and gᵢ=<lᵢ,sᵢ> is a graphoneme; lᵢ and sᵢ are aligned as one letter corresponding to one or more phonemes (including null).

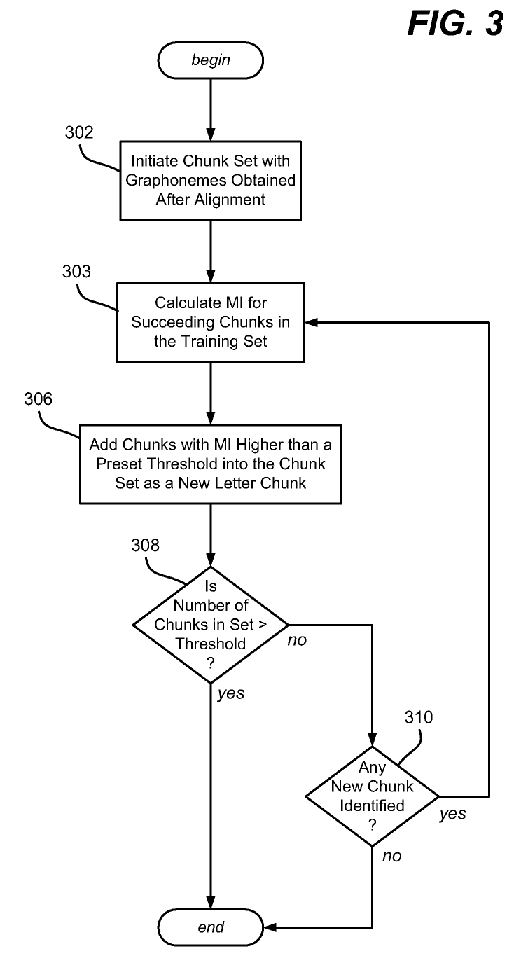

Some stable (more frequently observed) spelling-pronunciation chunks are extracted as independent units by which corresponding N-gram models are trained. For generating chunks, mutual information (MI) between any two chunks is calculated to decide whether those two chunks should be joined together to form one chunk. This process is exemplified in FIG. 3, beginning at step 302 which initiates the chunk set with the graphonemes obtained after alignment. Step 304 represents calculating the MI value for the succeeding chunks in the training set, and step 306 adds the chunks with an MI higher than a preset threshold into the chunk set as a new letter chunk.

Step 308 evaluates whether the number of chunks in the set is above a certain threshold, and if so, ends the process. If not at the threshold, step 310 evaluates whether any new chunk is identified, and if not, ends the process. Otherwise, the process returns to step 304.

In decoding, the paths of the possible pronunciations that match the input word spellings may be efficiently searched via the Viterbi algorithm, for example. The pronunciation that corresponds to the maximum likelihood path is retained as the final result.

Returning to FIG. 2, step 208 transfers the syllable boundary marks from the marked phonemes to the correspondingly aligned graphemes. Step 210 makes a list of the primary stressed syllables from the words in the dictionary.

Steps 212-217 represent generating the artificial data, in which the various words in the dictionary are used as the starting (seed) words. Via steps 212, 216 and 217, for each seed word, the primary stressed syllable is extracted (step 213) and compared with replacement candidates (e.g., provided by the candidate generator/evaluator 114, FIG. 1, such as by combining various consonants, digraphs and vowels) in the prepared list of stressed syllables. If the replacement rule (phonemic or graphonemic as described below) is satisfied, the primary stressed syllable is replaced at step 215; a new word is thus generated with a pronunciation corresponding to that of the seed word and is added to a new word list. After the seed words are processed, a new word list with pronunciations is provided as the artificial data 104.

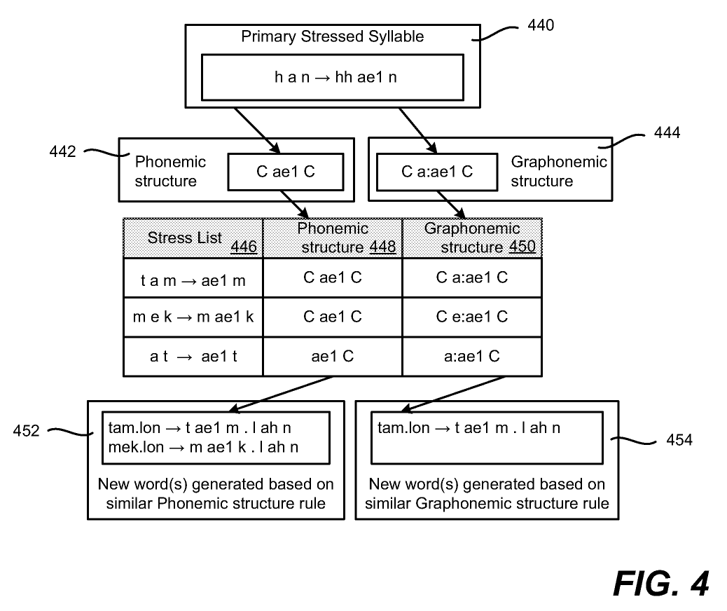

By way of example, FIG. 4 represents extracting structure for a syllable based upon its phoneme sequence. In FIG. 4, consonants are denoted by the symbol “C” in the structure, and stress is indicated by the numeral one (“1”). Thus, give a word “hanlon” in the dictionary as a seed word with a period separating the syllables, as aligned, “h a n . l o n” becomes “hh ae1 n . l ah n”.

The primary stressed syllable 440 is “han” as denoted by “hh ae1 n”, as represented in the phonemic structure 442 as “C ae1 C” and in the graphonemic structure 444 as “C a:ae1 C” (where “C” represents any consonant). As can be seen, in the phonemic structure 442, vowels are represented in their original phonemic symbol, while in the graphonemic structure 444, graphonemes of vowels (letter-phoneme symbol pair of the vowel) are used in the structure. Both conform to their positions in the original syllable. Replacement rules are based on these structures as described below.

More particularly, in one example implementation, with respect to the replacement rules, to generate words that are more plausible in letter spelling and/or phonemic structure, replacement may be based upon similar phonemic structure or similar graphonemic structure. In the example of FIG. 4, given the seed word “Hanlon”, candidate words in the stress list 446 are based on “tam” (tamlon), “mek” (meklon) and “at” (atlon). Each rule can generate its own new word list with corresponding pronunciations.

For the phonemic structure rule, corresponding to the phonemic structure 448, the seed word's phonemic structure is evaluated against the phonemic structures of the candidate words with respect to the stressed syllable's structure. Thus, “tamlon” and “meklon” are generated as new artificial words 452 because their phonemic structures match that of the seed word, namely “C ae1 C” in this example. The candidate word “atlon” is not a new word because it does not have the leading consonant in the match.

For the graphonemic structure rule, corresponding to the graphonemic structure 450, the seed word's graphonemic structure is evaluated against the graphonemic structures of the candidate words with respect to the stressed syllable. Thus, “tamlon” is generated as a new artificial word 454 because its graphonemic structure matches that of the seed word, namely “C a:ae1 C” in the example of FIG. 4. Neither “meklon” nor “atlon” become a new word because “meklon” does not match the vowel while “atlon” does not match the leading consonant. As can be readily appreciated, because of the need to match vowels and consonants, the graphonemic structure rule, along with its spelling conformation requirement, is more restrictive than the phonemic structure rule.

Turning to FIG. 5, there is shown an example framework for predicting pronunciations of new words based on semi-supervised learning. Semi-supervised learning may be used with unlabeled data to improve model training efficiency. In general, unlabeled samples are automatically annotated (labeled) using a classifier or the like trained on a relatively small labeled set comprising an original pronunciation dictionary 554; the LTS model or models 552 are then retrained or refined with additional automatically-labeled data, as exemplified in FIG. 5. Examples of such LTS models include cart regression trees, n-gram models (e.g., graphonemic), training models possibly split into separate parts, models that are similar to one another but have different settings/parameters, and so forth.

As described with reference to FIG. 5, agreement learning is one type of semi-supervised learning that uses multiple classifiers to separately classify unlabeled data. The labeling results that are in agreement among the different classifiers (e.g., some threshold number or all of the classifiers) are deemed as reliable, and are used for retraining. By way of example, in chunk N-gram based letter-to-sound training, different chunks may have different capabilities in characterizing the training set, e.g., the decoded pronunciation paths from three different chunk N-grams (such as when the number of chunks are 500, 1,000 and 3,000) are quite different, whereby only about half of the paths are the same. However, the word error rate after agreement is considered is significantly lower than the error rate of any individual model. Thus, although a large percentage of the results may not agree among multiple models, given a new word list that is large enough, sufficiently good new word candidates for retraining the letter-to-sound model may be generated.

More particularly, it is straightforward to extract new words from the Internet or other text databases. In this example framework, a spelling list 554 (e.g., containing words on the order of millions or tens of millions) is obtained from such a source. However, for the most part such extracted new words are not accompanied by pronunciations. For letter-to-sound training, the correct or probabilistically-likely correct pronunciations are generated for use as samples in the training data.

To this end, the words decoded into phonemes by a plurality of the models 552 (corresponding to models M1-Mm, where m is typically on the order of two to hundreds) are added to the training set. When a spelled word is processed by the LTS models 552 into phonemes, an agreement learning mechanism 556 evaluates the various results. If the models' results agree (diamond 558) with one another to a sufficient extent (e.g., some percentage of the models' phonemes correspond), then the word and its artificially generated phoneme pairing is added to a training set 560. Otherwise the word is discarded. Note that discarded words may be used in another manner, e.g., used as a data store for manual pronunciation.

The models 552 are then retrained (block 562) using the original pronunciation dictionary's words/phonemes and the new training set 560. The process continues with additional iterations. Note that some number of words may be added to the training set before the next re-training iteration. Each iteration may continue until the data that agrees after retraining via a current iteration is the same (or sufficiently similar to) the data from the last iteration.

It should be noted that the set of models may be varied for different circumstances. For example, models may be language-specific, based on geographic location (e.g., to match proper names of places) and so forth. Further, consideration may be based on desired styles of pronunciation/accents, such as whether the resultant LTS model is to have its words pronounced in an Anglicized style for an English-speaking audience, a French style for French-speaking audiences, and so on.

Still further, the various models in a given set need not be given the same weight with respect to each other in determining agreement. For example, if the source of words is known, such as primarily Japanese names from a Japanese company's employee database, then a Japanese LTS model may be given more weight than other models, although such other models are still useful for non-Japanese names as well as to the extent they may agree on Japanese names. A points-based scheme for example, instead of a percentage agreement scheme, facilitates such different weighting.

### Exemplary Operating Environment

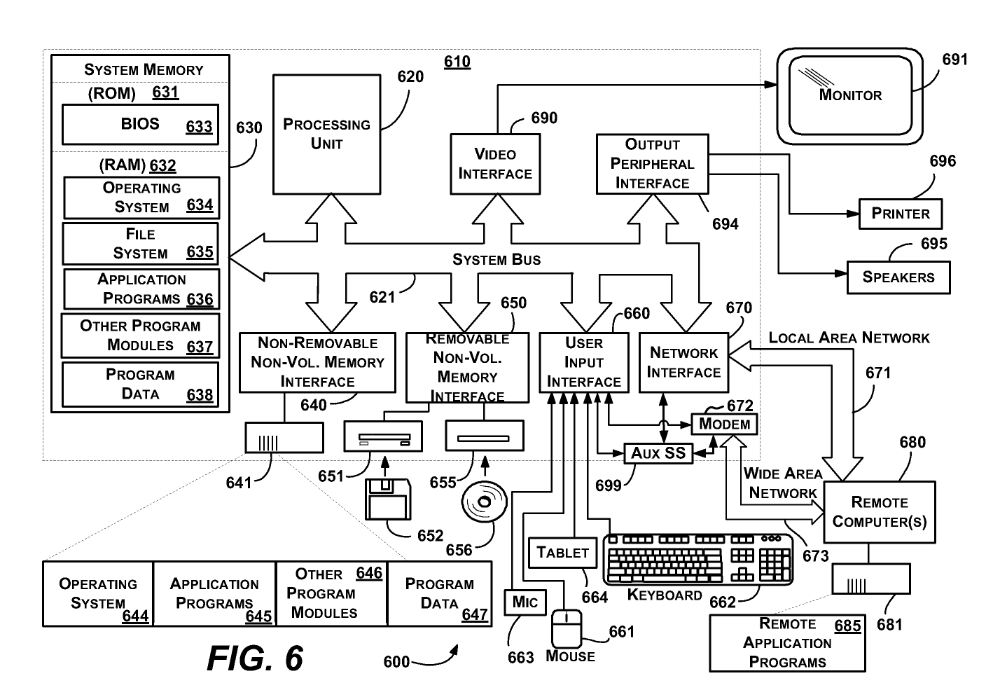

FIG. 6 illustrates an example of a suitable computing and networking environment 600 on which the examples of FIGS. 1-5 may be implemented. The computing system environment 600 is only one example of a suitable computing environment and is not intended to suggest any limitation as to the scope of use or functionality of the invention. Neither should the computing environment 600 be interpreted as having any dependency or requirement relating to any one or combination of components illustrated in the exemplary operating environment 600.

The invention is operational with numerous other general purpose or special purpose computing system environments or configurations. Examples of well known computing systems, environments, and/or configurations that may be suitable for use with the invention include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 6, an exemplary system for implementing various aspects of the invention may include a general purpose computing device in the form of a computer 610. Components of the computer 610 may include, but are not limited to, a processing unit 620, a system memory 630, and a system bus 621 that couples various system components including the system memory to the processing unit 620. The system bus 621 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 610 typically includes a variety of computer-readable media. Computer-readable media can be any available media that can be accessed by the computer 610 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer 610. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above may also be included within the scope of computer-readable media.

The system memory 630 includes computer storage media in the form of volatile and/or nonvolatile memory such as read only memory (ROM) 631 and random access memory (RAM) 632. A basic input/output system 633 (BIOS), containing the basic routines that help to transfer information between elements within computer 610, such as during start-up, is typically stored in ROM 631. RAM 632 typically contains data and/or program modules that are immediately accessible to and/or presently being operated on by processing unit 620. By way of example, and not limitation, FIG. 6 illustrates operating system 634, application programs 635, other program modules 636 and program data 637.

The computer 610 may also include other removable/non-removable, volatile/nonvolatile computer storage media. By way of example only, FIG. 6 illustrates a hard disk drive 641 that reads from or writes to non-removable, nonvolatile magnetic media, a magnetic disk drive 651 that reads from or writes to a removable, nonvolatile magnetic disk 652, and an optical disk drive 655 that reads from or writes to a removable, nonvolatile optical disk 656 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 641 is typically connected to the system bus 621 through a non-removable memory interface such as interface 640, and magnetic disk drive 651 and optical disk drive 655 are typically connected to the system bus 621 by a removable memory interface, such as interface 650.

The drives and their associated computer storage media, described above and illustrated in FIG. 6, provide storage of computer-readable instructions, data structures, program modules and other data for the computer 610. In FIG. 6, for example, hard disk drive 641 is illustrated as storing operating system 644, application programs 645, other program modules 646 and program data 647. Note that these components can either be the same as or different from operating system 634, application programs 635, other program modules 636, and program data 637. Operating system 644, application programs 645, other program modules 646, and program data 647 are given different numbers herein to illustrate that, at a minimum, they are different copies. A user may enter commands and information into the computer 610 through input devices such as a tablet, or electronic digitizer, 664, a microphone 663, a keyboard 662 and pointing device 661, commonly referred to as mouse, trackball or touch pad. Other input devices not shown in FIG. 6 may include a joystick, game pad, satellite dish, scanner, or the like. These and other input devices are often connected to the processing unit 620 through a user input interface 660 that is coupled to the system bus, but may be connected by other interface and bus structures, such as a parallel port, game port or a universal serial bus (USB). A monitor 691 or other type of display device is also connected to the system bus 621 via an interface, such as a video interface 690. The monitor 691 may also be integrated with a touch-screen panel or the like. Note that the monitor and/or touch screen panel can be physically coupled to a housing in which the computing device 610 is incorporated, such as in a tablet-type personal computer. In addition, computers such as the computing device 610 may also include other peripheral output devices such as speakers 695 and printer 696, which may be connected through an output peripheral interface 694 or the like.

The computer 610 may operate in a networked environment using logical connections to one or more remote computers, such as a remote computer 680. The remote computer 680 may be a personal computer, a server, a router, a network PC, a peer device or other common network node, and typically includes many or all of the elements described above relative to the computer 610, although only a memory storage device 681 has been illustrated in FIG. 6. The logical connections depicted in FIG. 6 include one or more local area networks (LAN) 671 and one or more wide area networks (WAN) 673, but may also include other networks. Such networking environments are commonplace in offices, enterprise-wide computer networks, intranets and the Internet.

When used in a LAN networking environment, the computer 610 is connected to the LAN 671 through a network interface or adapter 670. When used in a WAN networking environment, the computer 610 typically includes a modem 672 or other means for establishing communications over the WAN 673, such as the Internet. The modem 672, which may be internal or external, may be connected to the system bus 621 via the user input interface 660 or other appropriate mechanism. A wireless networking component 674 such as comprising an interface and antenna may be coupled through a suitable device such as an access point or peer computer to a WAN or LAN. In a networked environment, program modules depicted relative to the computer 610, or portions thereof, may be stored in the remote memory storage device. By way of example, and not limitation, FIG. 6 illustrates remote application programs 685 as residing on memory device 681. It may be appreciated that the network connections shown are exemplary and other means of establishing a communications link between the computers may be used.

An auxiliary subsystem 699 (e.g., for auxiliary display of content) may be connected via the user interface 660 to allow data such as program content, system status and event notifications to be provided to the user, even if the main portions of the computer system are in a low power state. The auxiliary subsystem 699 may be connected to the modem 672 and/or network interface 670 to allow communication between these systems while the main processing unit 620 is in a low power state.

### Conclusion

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. In a computing environment, a method comprising:
generating an artificial word set comprising at least one artificial word based on a seed word; and
using the artificial word set to provide a letter-to-sound conversion model.

2. The method of claim 1 wherein generating the artificial word set includes replacing a stressed syllable of the seed word with a different syllable.

3. The method of claim 1 wherein generating the artificial words includes evaluating a stressed syllable of the seed word against a candidate syllable, and if the evaluation indicates a sufficient match, replacing the stressed syllable of the seed word with the candidate syllable.

4. The method of claim 3 wherein evaluating the stressed syllable of the seed word against the candidate syllable comparing a phonemic structure corresponding to the seed word with a phonemic structure corresponding to the candidate syllable.

5. The method of claim 3 wherein evaluating the stressed syllable of the seed word against the candidate syllable comparing a graphonemic structure corresponding to the seed word with a graphonemic structure corresponding to the candidate syllable.

6. The method of claim 1 further comprising, generating artificial phonemes from words, and using the artificial phonemes in training at least one letter-to-sound conversion model.

7. The method of claim 6 wherein generating the artificial phonemes from the words comprises generating a plurality of phonemes corresponding to a plurality of models from a selected word, determining whether the plurality of phonemes for the selected word are in agreement with respect to an agreement threshold, and if so, including the word and an associated phoneme in a training set.

8. In a computing environment, a system comprising:
a candidate generator that generates candidate parts of speech corresponding to a seed word; and
a mechanism that evaluates the candidate parts against a similar part of the seed word, and for each candidate part in which the evaluation meets a rule, generates an artificial word based on the candidate part and another part of the seed word.

9. The system of claim 8 wherein the candidate parts of speech each correspond to a candidate syllable, and wherein the similar part of the seed word comprises a primary stressed syllable.

10. The system of claim 9 wherein the rule is met when the consonant pattern of the candidate syllable corresponds to the consonant pattern of the primary stressed syllable of the seed word, or when the consonant pattern and vowel sound of the candidate syllable corresponds to the consonant pattern and vowel sound of the primary stressed syllable of the seed word.

11. The system of claim 9 wherein the primary stressed syllable is represented in a first phonemic structure, wherein each candidate syllable is represented in a second phonemic structure, and wherein the rule is met when the first and second phonemic structures match one another.

12. The system of claim 9 wherein the primary stressed syllable is represented in a first graphonemic structure, wherein each candidate syllable is represented in a second graphonemic structure, and wherein the rule is met when the first and second graphonemic structures match one another.

13. The system of claim 8 further comprising, a set of models that generate artificial phonemes from a word, and an agreement learning mechanism coupled to the set of models to determine whether the artificial phonemes for that word achieve a threshold agreement, and if so, to add the word and an associated phoneme to a training set used in retraining the models.

14. One or more computer-readable media having computer-executable instructions, which when executed perform steps, comprising:
selecting a seed word;
comparing a stressed syllable of the seed word against a candidate syllable with respect to a replacement rule; and
when the stressed syllable of the seed word and the candidate syllable satisfy the replacement rule, generating a different word from the seed word by replacing the stressed syllable of the seed word with the candidate syllable to form the different word.

15. The one or more computer-readable media of claim 14 wherein the replacement rule comprises a phonemic structure rule, and wherein comparing the stressed syllable of the seed word against the candidate syllable comprises evaluating a phonemic structure corresponding to the stressed syllable with a phonemic structure corresponding to the candidate syllable.

16. The one or more computer-readable media of claim 14 wherein the replacement rule comprises a graphonemic structure rule, and wherein comparing the stressed syllable of the seed word against the candidate syllable comprises evaluating a graphonemic structure corresponding to the stressed syllable with a graphonemic structure corresponding to the candidate syllable.

17. The one or more computer-readable media of claim 14 having further computer-executable instructions comprising, providing the different word for use with a letter-to-sound conversion model.

18. The one or more computer-readable media of claim 17 having further computer-executable instructions comprising, using the letter-to-sound conversion model to generating artificial phonemes from a source of words.

19. The one or more computer-readable media of claim 18 wherein generating the artificial phonemes from the source of words comprises generating a plurality of phonemes from a selected source word, determining whether the plurality of phonemes for the selected source word are in agreement relative to one another with respect to an agreement threshold, and if so, including the selected source word and an associated artificial phoneme for that selected source word in a training set.

20. The one or more computer-readable media of claim 19 having further computer-executable instructions comprising, using the training set to retrain the letter-to-sound conversion model.
